(19) United States
(12) Patent Application Publication
(10) Pub. No.: US 2026/0331731 A1
(43) Pub. Date: Oct. 22, 2026

(54) SECONDARY BATTERY AND BATTERY ASSEMBLY

(71) Applicant: Prime Planet Energy & Solutions, Inc., Tokyo (JP)

(72) Inventors: Daiki WATANABE, Kakogawa-shi (JP); Tomoyuki YAMADA, Kobe-shi (JP)

(21) Appl. No.: 19/634,070

(22) Filed: Mar. 31, 2026

(30) Foreign Application Priority Data
Apr. 2, 2025 (JP) 2025-061240

(51) Int. Cl. H01M 50/586; H01M 10/0585; H01M 50/103; H01M 50/209; H01M 50/289; H01M 50/595

(52) U.S. Cl. CPC H01M 50/586; H01M 10/0585; H01M 50/103; H01M 50/209; H01M 50/289; H01M 50/595

(57) ABSTRACT

A first surface of an exterior container has a substantially rectangular shape including a pair of first end sides each extending in a first direction and a pair of second end sides each extending in a second direction substantially orthogonal to the first direction. An insulating member is provided in a vicinity of at least one of the pair of first end sides, has a first region extending in a form of a strip in the first direction, and has a second region located on a center side of the insulating member with respect to the first region in the second direction. A thickness of the insulating member in the first region is larger than a thickness of the insulating member in the second region.

### CROSS REFERENCE TO RELATED APPLICATIONS

This nonprovisional application is based on Japanese Patent Application No. 2025-061240 filed on Apr. 2, 2025 with the Japan Patent Office, the entire contents of which are hereby incorporated by reference.

### BACKGROUND OF THE INVENTION

### Field of the Invention

The present technology relates to a secondary battery and a battery assembly.

### Description of the Background Art

Japanese Patent Laying-Open No. 2021-177471 discloses a prismatic battery in which a sheet-shaped insulating member is inserted into a battery case together with an electrode assembly in a state in which the sheet-shaped insulating member is bent to be along a surface of the electrode assembly.

### SUMMARY OF THE INVENTION

It has been required to suppress precipitation of metal in a secondary battery. When a battery assembly is formed from secondary batteries each having an exterior container having a prismatic shape, a pressure load is likely to be relatively small in the vicinity of an end side of a surface of the exterior container having a substantially rectangular shape. Due to variation in the pressure load, a resistance difference is caused in the electrode assembly, thereby facilitating occurrence of the precipitation of metal. It has been required to effectively suppress the precipitation of metal at a portion at which the pressure load is relatively small. From this viewpoint, there is still room for improvement in a conventional secondary battery.

An object of the present technology is to provide: a secondary battery in which precipitation of metal is suppressed; and a battery assembly including the secondary battery.

The present technology provides the following secondary battery and the following battery assembly.
[1] A secondary battery comprising: an electrode assembly including a main body portion and an electrode tab; an insulating member provided outside the electrode assembly; and an exterior container that has a prismatic shape and that accommodates the electrode assembly and the insulating member, wherein the exterior container has a pair of first surfaces, a pair of second surfaces substantially orthogonal to the first surfaces, and a pair of third surfaces substantially orthogonal to the first surfaces and the second surfaces, and an area of each of the first surfaces is larger than each of an area of each of the second surfaces and an area of each of the third surfaces, the first surface has a substantially rectangular shape including a pair of first end sides each extending in a first direction and a pair of second end sides each extending in a second direction substantially orthogonal to the first direction, the insulating member has a first region provided in a vicinity of at least one of the pair of first end sides and extending in a form of a strip in the first direction, and has a second region located on a center side of the insulating member with respect to the first region in the second direction, the first region and the second region are provided to overlap the main body portion of the electrode assembly in a third direction orthogonal to the first direction and the second direction, and a thickness of the insulating member in the first region is larger than a thickness of the insulating member in the second region.
[2] The secondary battery according to [1], wherein the first region is provided in a vicinity of each of the pair of first end sides.
[3] The secondary battery according to [1] or [2], wherein the first region is provided across an entire length of the main body portion of the electrode assembly in the first direction.
[4] The secondary battery according to any one of [1] to [3], wherein in the first region, a plurality of sheet members constituting the insulating member are overlapped.
[5] The secondary battery according to any one of [1] to [4], wherein in the first region, an adhesive layer or a tape is integrated with the insulating member.
[6] The secondary battery according to any one of [1] to [5], wherein the pair of first end sides are long sides.
[7] The secondary battery according to any one of [1] to [6], wherein the electrode assembly has an electrode tab at a position facing each of the pair of second end sides.
[8] The secondary battery according to any one of [1] to [7], wherein the electrode assembly is a stacked type electrode assembly.
[9] The secondary battery according to any one of [1] to [8], wherein a thickness of the insulating member in the first region is larger than a thickness of the insulating member in the second region by 10 μm or more.
[10] The secondary battery according to any one of [1] to [9], wherein the first region has a width of 2 mm or more in the second direction.
[11] A battery assembly comprising: a plurality of the secondary batteries according to any one of [1] to [10], the plurality of the secondary batteries being arranged side by side in the third direction; and an inter-cell separator provided between the plurality of the secondary batteries, wherein the inter-cell separator is disposed to overlap the first region of the insulating member as viewed in the third direction.
[12] The battery assembly according to [11], wherein the plurality of the secondary batteries and the inter-cell separator are restrained by a load of 10 kN or more in the third direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to an embodiment.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a diagram showing a state in which the secondary battery shown in FIG. 1 is viewed in a direction of arrow IV.

FIG. 5 is a diagram showing a state in which the secondary battery shown in FIG. 1 is viewed in a direction of arrow V.

FIG. 6 is a front cross sectional view of the secondary battery shown in FIG. 1.

FIG. 7 is a cross sectional view of a negative electrode plate.

FIG. 8 is a front view showing the negative electrode plate.

FIG. 9 is a cross sectional view of a positive electrode plate.

FIG. 10 is a front view showing the positive electrode plate.

FIG. 11 is a perspective view showing a state of attaching a sealing plate to a current collector on the positive electrode side.

FIG. 12 is a perspective view showing the configuration of the secondary battery.

FIG. 13 is a diagram of the secondary battery and an inter-cell separator adjacent to the secondary battery as viewed in a stacking direction.

FIG. 14 is a cross sectional view of the secondary battery and the inter-cell separator.

FIG. 15 is a perspective view showing a state in which an electrode assembly holder is attached to an electrode assembly.

FIG. 16 is an exploded perspective view of the electrode assembly holder shown in FIG. 15.

FIG. 17 is a perspective view showing a state in which an electrode assembly holder according to a modification is attached to the electrode assembly.

FIG. 18 is a development view of a sheet-shaped member constituting the electrode assembly holder shown in FIG. 17.

FIG. 19 is a cross sectional view showing a positional relation between the electrode assembly holder and the inter-cell separator.

FIG. 20 is an enlarged view of a portion XX in FIG. 19.

FIG. 21 is a diagram showing a step of inserting the electrode assembly together with pressure-sensitive paper into the case main body.

FIG. 22 is a cross sectional view of a portion XXII in FIG. 21.

FIG. 23 is a diagram showing a load test on the secondary battery.

FIG. 24 is a diagram showing a color development range of pressure-sensitive paper in a secondary battery according to a comparative example.

FIG. 25 is a diagram showing a color development range of pressure-sensitive paper in the secondary battery according to the embodiment.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

Moreover, sizes such as width, length, and diameter of each member illustrated in the present specification are not limited to those shown in the figures, and can be appropriately changed. In the present specification, ordinal numbers such as “first” and “second” may be given to respective configurations, but these ordinal numbers do not limit priority, order, or the like unless explicitly defined.

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode. Further, the term “electrode plate” may collectively represent a positive electrode plate and a negative electrode plate.

In the present specification, the “battery” can be mounted on vehicles such as a hybrid electric vehicle (HEV), a plug-in hybrid electric vehicle (PHEV), and a battery electric vehicle (BEV). It should be noted that the use of the “battery” is not limited to the use in a vehicle.

In the present specification, the X direction (first direction) may be referred to as a “width direction” of each of the secondary battery, the electrode assembly, and the case main body, the Z direction (second direction) may be referred to as a “height direction” of the secondary battery, the electrode assembly, and the case main body, and the Y direction (third direction) may be referred to as a “thickness direction” of the secondary battery, the electrode assembly, and the case main body.

### Overall Configuration of Secondary Battery

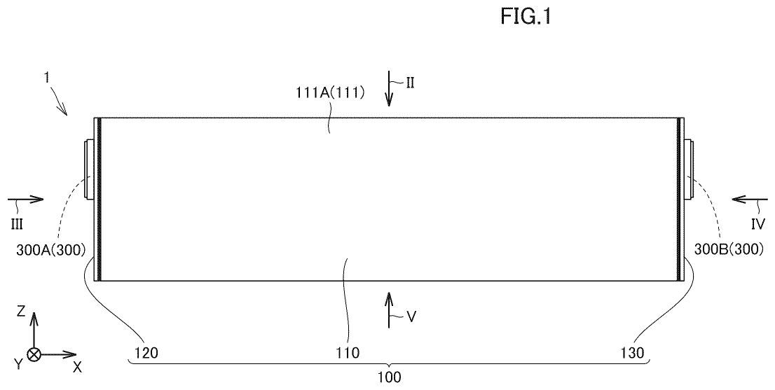

The overall configuration of a secondary battery 1 will be described with reference to FIGS. 1 to 6. Secondary battery 1 includes a case 100 (exterior container), an electrode assembly 200, electrode terminals 300, and current collectors 400. Case 100 includes a case main body 110, a sealing plate 120, and a sealing plate 130.

When forming a battery assembly including secondary battery 1, a plurality of secondary batteries 1 are stacked in the thickness direction of each of the plurality of secondary batteries 1. Secondary batteries 1 stacked may be restrained in the stacking direction (Y direction) by a restraint member to form a battery module, or the battery assembly may be directly supported by a side surface of a case of a battery pack without using the restraint member.

Case main body 110 is constituted of a member having a tubular shape, preferably, a prismatic tubular shape. Thus, secondary battery 1 including case 100 having a prismatic shape is obtained. Case main body 110 is composed of a metal. Specifically, case main body 110 is composed of aluminum, an aluminum alloy, iron, an iron alloy, or the like.

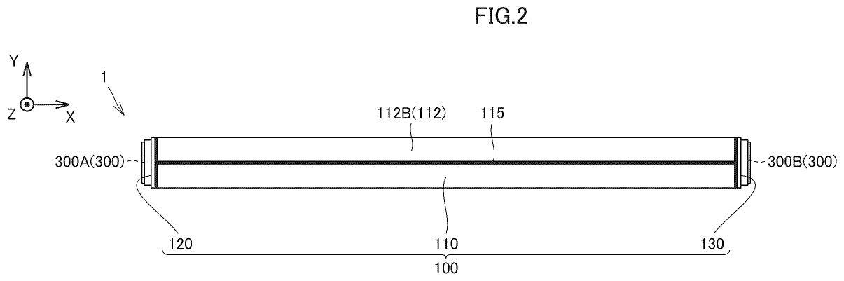

As shown in FIGS. 1 and 2, sealing plate 120 and sealing plate 130 are provided at respective end portions of the case main body. Case main body 110 can be formed to have a prismatic tubular shape in, for example, the following manner: end sides of a plate-shaped member having been bent are brought into abutment with each other (joining portion 115 illustrated in FIG. 2) and are joined together (for example, energy ray application such as laser welding is favorable). Each of the corners of the “prismatic tubular shape” may have a shape with a curvature.

In the present embodiment, case main body 110 is formed to be longer in the width direction (X direction) of secondary battery 1 than in each of the thickness direction (Y direction) and the height direction (Z direction) of secondary battery 1. The size (width) of case main body 110 in the X direction is preferably about 300 mm or more. In this way, secondary battery 1 can be formed to have a relatively large size (high capacity). The size (height) of case main body 110 in the Z direction is preferably about 100 mm or less. Thus, (low-height) secondary battery 1 having a relatively low height can be formed, thus resulting in improved ease of mounting on a vehicle, for example. However, the sizes of secondary battery 1 are not limited to the above ranges.

Case main body 110 includes first side surface portions 111 (first surfaces) and second side surface portions 112 (second surfaces). First side surface portions 111 are constituted of a pair of first side surface portions 111A, 111B, whereas second side surface portions 112 are constituted of a pair of second side surface portions 112A, 112B. First side surface portions 111A, 111B constitute parts of the side surfaces of case 100. The pair of second side surface portions 112A, 112B constitute the bottom surface portion and upper surface portion of case 100. First side surface portions 111 and second side surface portions 112 are provided to intersect each other. First side surface portions 111 and second side surface portions 112 are connected at their respective end portions.

As shown in FIG. 5, a gas-discharge valve 150 is provided in one second side surface portion 112A of second side surface portions 112. Gas-discharge valve 150 extends in the width direction (X direction) of secondary battery 1. Gas-discharge valve 150 extends from the center of case main body 110 in the X direction to such an extent that gas-discharge valve 150 does not reach both ends of case main body 110 in the X direction. The shape of gas-discharge valve 150 can be changed appropriately.

The thickness of the plate-shaped member in gas-discharge valve 150 is thinner than the thickness of the plate-shaped member of case main body 110 other than gas-discharge valve 150. Thus, when the pressure in case 100 becomes equal to or more than a predetermined value, gas-discharge valve 150 is fractured prior to the other portions of case main body 110, thereby discharging the gas in case 100 to the outside.

As shown in FIG. 2, joining portion 115 is formed at the other second side surface portion 112B of second side surface portions 112. Joining portion 115 extends in the width direction (X direction) of secondary battery 1. At joining portion 115, the end sides of the plate-shaped member constituting case main body 110 are joined to each other.

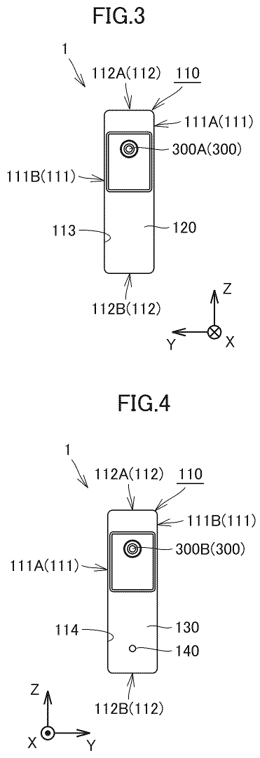

As shown in FIG. 3, an opening 113 (first opening) is provided at an end portion of case main body 110 on one side in the first direction (X direction). Opening 113 is sealed by sealing plate 120 (first sealing plate). Joining portion 115 is formed at opening 113 so as to seal opening 113. Each of opening 113 and sealing plate 120 has a substantially rectangular shape in which the Y direction corresponds to its short-side direction and the Z direction corresponds to its long-side direction. The substantially rectangular shape includes a rectangular shape or a generally rectangular shape such as a rectangular shape having corners each with a curvature.

A negative electrode terminal 300A is provided on sealing plate 120. The position of negative electrode terminal 300A can be appropriately changed.

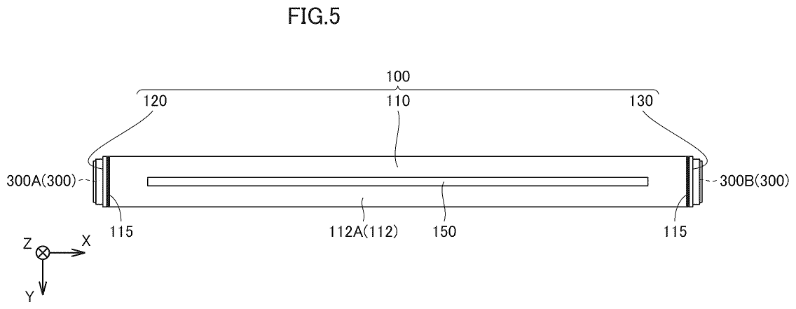

As shown in FIG. 4, an opening 114 (second opening) is provided at an end portion of case main body 110 on the other side in the X direction. That is, opening 114 is located at an end portion opposite to opening 113, and openings 113 and 114 face each other. Opening 114 is sealed by sealing plate 130 (second sealing plate). Joining portion 115 is formed at opening 114 so as to seal opening 114. Each of opening 114 and sealing plate 130 has a substantially rectangular shape in which the Y direction corresponds to its short-side direction and the Z direction corresponds to its long-side direction.

Sealing plate 130 is provided with a positive electrode terminal 300B and an injection hole 140. The positions of positive electrode terminal 300B and injection hole 140 can be appropriately changed. Injection hole 140 is sealed by a sealing member (not shown). As the sealing member, for example, a blind rivet or another metal member can be used.

Each of sealing plate 120 and sealing plate 130 is composed of a metal. Specifically, each of sealing plate 120 and sealing plate 130 is composed of aluminum, an aluminum alloy, iron, an iron alloy, or the like.

Sealing plates 120, 130 (third surfaces) constitute parts of case 100. Sealing plates 120, 130 are provided to intersect (provided to be substantially orthogonal to) first side surface portions 111 and second side surface portions 112.

In case 100, the area (first area) of each of the pair of first side surface portions 111 (first surfaces) is larger than each of the area (second area) of each of the pair of second side surface portions 112 (second surfaces) and the area (third area) of each of sealing plates 120, 130 (third surfaces).

Negative electrode terminal 300A is electrically connected to a negative electrode of electrode assembly 200. Negative electrode terminal 300A is attached to sealing plate 120, i.e., case 100. Positive electrode terminal 300B is electrically connected to a positive electrode of electrode assembly 200. Positive electrode terminal 300B is attached to sealing plate 130, i.e., case 100.

Negative electrode terminal 300A is composed of a conductive material (more specifically, a metal), and may be composed of, for example, copper or a copper alloy. Positive electrode terminal 300B is composed of a conductive material (more specifically, a metal), and may be composed of, for example, aluminum or an aluminum alloy.

Electrode assembly 200 is an electrode assembly having a flat shape and having a below-described negative electrode plate 210 and a below-described positive electrode plate 220 stacked on each other. Specifically, electrode assembly 200 is a stacked type electrode assembly in which a plurality of negative electrode plates 210 and a plurality of positive electrode plates 220 are alternately stacked with a separator being interposed therebetween. The separator may be formed by folding a strip-shaped insulating sheet member in a meandering manner, or may be formed by individually providing a plurality of divided insulating sheets. In the present specification, the “electrode assembly” is not limited to the stacked type electrode assembly, and may be a wound type electrode assembly in which a strip-shaped negative electrode plate and a strip-shaped positive electrode plate are wound together with a strip-shaped separator being interposed therebetween. The separator can be constituted of, for example, a microporous membrane composed of polyolefin.

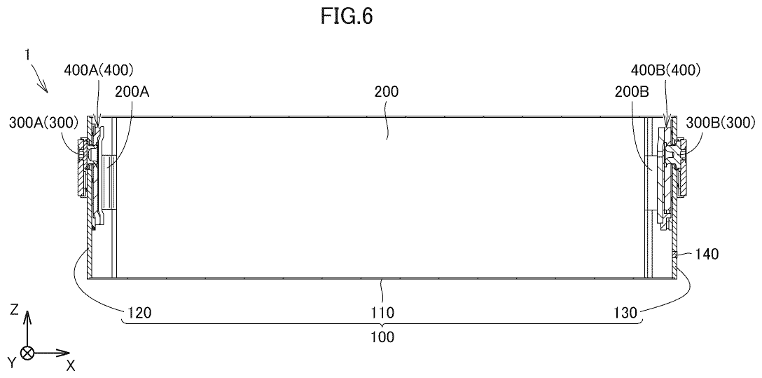

As shown in FIG. 6, case 100 accommodates electrode assembly 200. Electrode assembly 200 is accommodated in case 100 such that the long-side direction thereof is parallel to the X direction. Specifically, one or a plurality of the stacked type electrode assemblies and an electrolyte solution (electrolyte) (not shown) are accommodated in case 100. As the electrolyte solution (non-aqueous electrolyte solution), it is possible to use, for example, a solution obtained by dissolving LiPF₆ in a non-aqueous solvent. Instead of the electrolyte solution, a solid electrolyte may be used.

Electrode assembly 200 includes a main body portion having a substantially rectangular shape, a negative electrode tab group 200A, and a positive electrode tab group 200B.

The main body portion is constituted of below-described negative electrode plate 210 and below-described positive electrode plate 220. Negative electrode tab group 200A is located at an end portion of electrode assembly 200 on one side (the sealing plate 120 side) with respect to the main body portion thereof in the X direction. Positive electrode tab group 200B is located at an end portion of electrode assembly 200 on the other side (the sealing plate 130 side) with respect to the main body portion thereof in the X direction.

Each of negative electrode tab group 200A and positive electrode tab group 200B is formed to protrude from a central portion of electrode assembly 200 toward sealing plate 120 or sealing plate 130.

Current collectors 400 include a negative electrode current collector 400A and a positive electrode current collector 400B. Each of negative electrode current collector 400A and positive electrode current collector 400B is constituted of a plate-shaped member. Electrode assembly 200 is electrically connected to negative electrode terminal 300A and positive electrode terminal 300B through current collectors 400.

Negative electrode current collector 400A is disposed on sealing plate 120 with an insulating member composed of a resin being interposed therebetween. Negative electrode current collector 400A is electrically connected to negative electrode tab group 200A and negative electrode terminal 300A. Negative electrode current collector 400A is composed of a conductive material (more specifically, a metal), and can be composed of copper, a copper alloy, or the like, for example.

Positive electrode current collector 400B is disposed on sealing plate 130 with an insulating member composed of a resin being interposed therebetween. Positive electrode current collector 400B is electrically connected to positive electrode tab group 200B and positive electrode terminal 300B. Positive electrode current collector 400B is composed of a conductive material (more specifically, a metal), and can be composed of aluminum, an aluminum alloy, or the like, for example. Positive electrode tab group 200B may be electrically connected to sealing plate 130 directly or via positive electrode current collector 400B. In this case, sealing plate 130 may serve as positive electrode terminal 300B.

### Configuration of Electrode Assembly 200

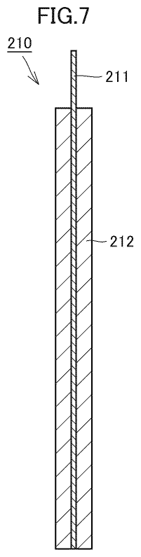

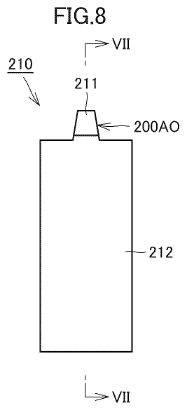

As shown in FIGS. 7 and 8, negative electrode plate 210 includes a negative electrode core body 211 and a negative electrode active material layer 212. A negative electrode tab 200A0 constituted of negative electrode core body 211 is provided at one end portion, in the width direction, of negative electrode plate 210. When negative electrode plates 210 are stacked, a plurality of negative electrode tabs 200A0 are stacked to form negative electrode tab group 200A. Negative electrode tab group 200A is electrically connected to the negative electrode. The length of each of negative electrode tabs 200A0 in the plurality of negative electrode plates 210 in the protruding direction is appropriately adjusted in consideration of the state in which negative electrode tab group 200A is connected to negative electrode current collector 400A. The shape of negative electrode tab 200A0 is not limited to the one illustrated in FIG. 8.

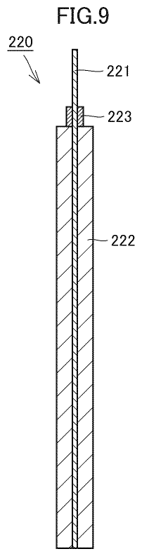

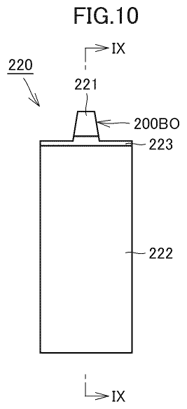

As shown in FIGS. 9 and 10, positive electrode plate 220 includes a positive electrode core body 221, a positive electrode active material layer 222, and a positive electrode protective layer 223. A positive electrode tab 200B0 constituted of positive electrode core body 221 is provided at one end portion, in the width direction, of positive electrode plate 220. When positive electrode plates 220 are stacked, a plurality of positive electrode tabs 200B0 are stacked to form positive electrode tab group 200B. Positive electrode tab group 200B is electrically connected to the positive electrode. The length of each of positive electrode tabs 200B0 in the plurality of positive electrode plates 220 in the protruding direction is appropriately adjusted in consideration of the state in which positive electrode tab group 200B is connected to positive electrode current collector 400B. The shape of positive electrode tab 200B0 is not limited to the one illustrated in FIG. 10.

Positive electrode protective layer 223 is provided at the root of positive electrode tab 200B0. Positive electrode protective layer 223 may not necessarily be provided at the root of positive electrode tab 200B0.

### Accommodation of Electrode Assembly 200

Electrode assembly 200 is inserted into case main body 110 from opening 113 with the positive electrode tab group 200B side being inserted first. As shown in FIG. 11, a spacer 500 is provided between electrode assembly 200 and sealing plate 130 located on the positive electrode side. A spacer 500 is also provided between electrode assembly 200 and sealing plate 120 located on the negative electrode side in the same manner as on the positive electrode side.

Before inserting electrode assembly 200 into case main body 110, electrode assembly 200 and negative electrode terminal 300A may be electrically connected to each other. After electrode assembly 200 is inserted into case main body 110, electrode assembly 200 is electrically connected to positive electrode terminal 300B.

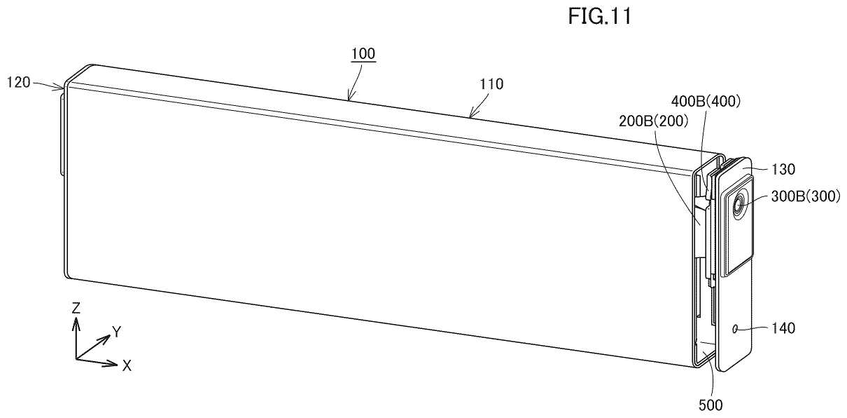

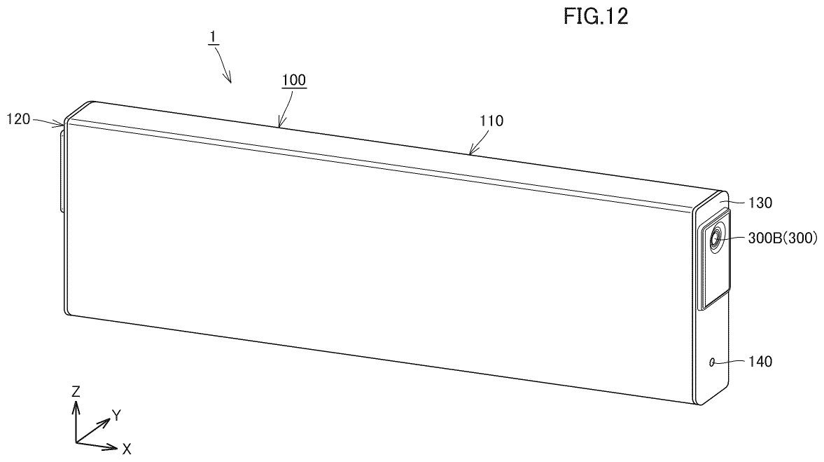

After electrode assembly 200 is inserted into case main body 110, sealing plate 120 and sealing plate 130 are joined to case main body 110 as shown in FIG. 12. Sealing plate 120 seals opening 113 of case main body 110, and sealing plate 130 seals opening 114 of case main body 110. In this way, electrode assembly 200 is accommodated in case main body 100.

### Configuration of Battery Assembly

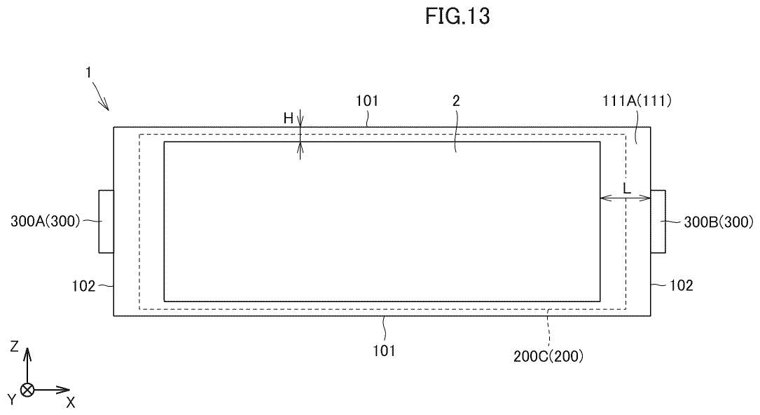

As shown in FIG. 13, first side surface portion 111 of case main body 110 has a substantially rectangular shape including a pair of first end sides 101 each extending in the X direction and a pair of second end sides 102 each extending in the Z direction. Here, each of the pair of first end sides 101 is longer than each of the pair of second end sides 102. That is, first side surface portion 111 has a substantially rectangular shape in which the X direction corresponds to the long-side direction thereof and the Z direction corresponds to the short-side direction thereof.

When forming a battery assembly, a plurality of secondary batteries 1 are arranged side by side in the Y direction. An inter-cell separator 2 is provided between the plurality of secondary batteries 1. The plurality of secondary batteries 1 and inter-cell separator 2 are restrained by a predetermined load in the Y direction.

As shown in FIG. 13, as viewed in the Y direction, the area of inter-cell separator 2 is smaller than the area of first side surface portion 111 of case main body 110. Specifically, in the Z direction, inter-cell separator 2 is provided in a region internal to each of the pair of first end sides 101 by a distance H (for example, H=about 3 mm), and in the X direction, inter-cell separator 2 is provided in a region internal to each of the pair of second end sides 102 by a distance L (for example, L=about 15 mm).

Electrode assembly 200 has a main body portion 200C having a substantially rectangular shape and other than negative electrode tab group 200A and positive electrode tab group 200B (electrode tabs). A separation distance (first distance) between the inner surface of case 100 and main body portion 200C of electrode assembly 200 in the Z direction is smaller than a separation distance (second distance) between the inner surface of case 100 and main body portion 200C of electrode assembly 200 in the X direction.

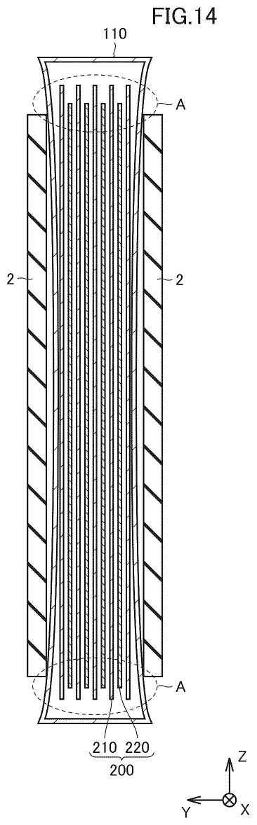

As shown in FIG. 14, when a restraining load in the Y direction acts on case main body 110 from inter-cell separator 2, case main body 110 is deformed more at its central portion in the Z direction than at its end portion in the Z direction. Thus, when the load in the Y direction is applied, the vicinity of each of first end sides 101 (portions A in FIG. 14) is less likely to be deformed and the pressure load is likely to be relatively small. As described later, electrode assembly holder 600 according to the present embodiment has a configuration to suppress decreased pressure load in the vicinity of first end side 101.

### Configuration of Electrode Assembly Holder 600

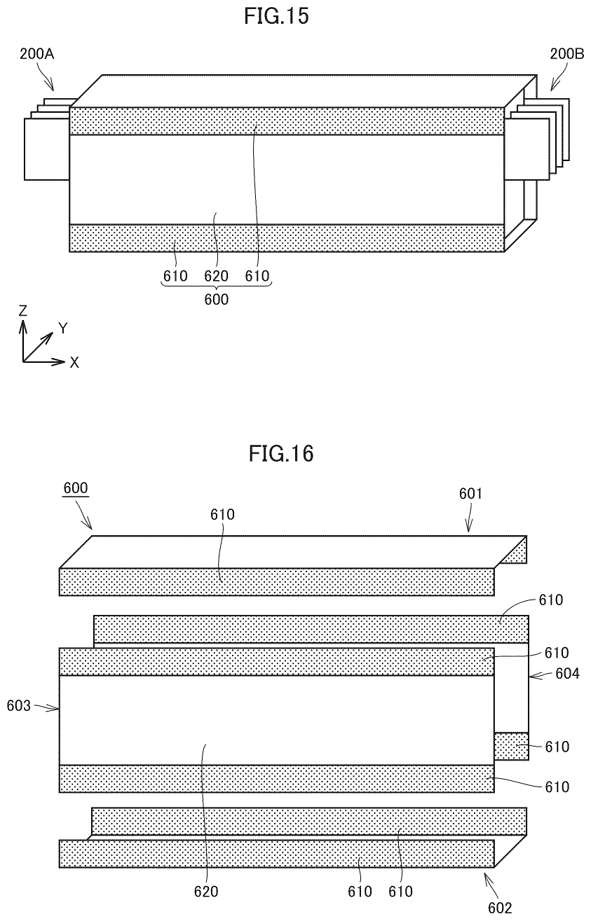

As shown in FIG. 15, electrode assembly holder 600 (insulating member) is provided outside electrode assembly 200. Electrode assembly holder 600 is composed of a sheet-shaped material having an insulation property. Electrode assembly holder 600 is accommodated in case 100 together with electrode assembly 200.

Electrode assembly holder 600 is composed of a resin, for example. As the resin of electrode assembly holder 600, polyethylene (PE) or polypropylene (PP) is preferably used. However, the resin of electrode assembly holder 600 is not limited thereto, and it is possible to use: an olefin-based resin such as polymethylpentene (PMP); a polyester-based resin such as polyethylene terephthalate (PET) and polyethylene naphthalate (PEN); a fluororesin such as polytetrafluoroethylene (PTFE); an acrylic resin (PMMA); polyimide (PI); polyphenylene ether (PPE); triacetate (TAC); a polyphenylene sulfide resin (PPS); polycarbonate (PC); nylon; or the like, for example. Electrode assembly holder 600 may be porous or non-porous.

Electrode assembly holder 600 may be formed to have a prismatic tubular shape, or may be formed to have a box shape or a pouch shape. Electrode assembly holder 600 is preferably provided with a region through which an electrolyte solution and a gas can pass. The region through which the electrolyte solution and the gas can pass preferably faces gas-discharge valve 150. Thus, the gas generated in electrode assembly 200 can be facilitated to be discharged to the outside of case 100 through gas-discharge valve 150.

Electrode assembly holder 600 has first regions 610 and a second region 620. First regions 610 are provided at its end portions in the Z direction, i.e., in the vicinity of the pair of first end sides 101 of case main body 110. Each of first regions 610 extends in the form of a strip in the X direction. First region 610 preferably extends continuously. However, first region 610 may be intermittently formed. As shown in FIG. 15, first region 610 is preferably provided across the entire length of main body portion 200C of electrode assembly 200 in the X direction. However, first region 610 may be provided only at a portion of main body portion 200C of electrode assembly 200.

Second region 620 is provided between two first regions 610. Second region 620 is located on the center side of electrode assembly holder 600 with respect to first regions 610 in the Z direction. Each of first regions 610 is provided to overlap main body portion 200C of electrode assembly 200 (in the case of the wound type electrode assembly, a flat surface other than a curved portion at its end portion in the Z direction) in the Y direction.

As shown in the exploded perspective view of FIG. 16, electrode assembly holder 600 is constituted of a first member 601, a second member 602, a third member 603, and a fourth member 604. In first region 610 on the upper side (+Z side) in FIG. 15, first member 601 overlaps third member 603 and fourth member 604. In first region 610 on the lower side (−Z side) in FIG. 15, second member 602, third member 603, and fourth member 604 overlap one another. Therefore, the thickness of electrode assembly holder 600 in first region 610 is larger than the thickness of electrode assembly holder 600 in second region 620.

Each of first member 601, second member 602, third member 603, and fourth member 604 is composed of a sheet-shaped material. First member 601, second member 602, third member 603, and fourth member 604 may be composed of the same material or different materials. First member 601, second member 602, third member 603, and fourth member 604 may have the same thickness or different thicknesses. It is preferable that first member 601 and second member 602 are disposed on the outer side (side not facing electrode assembly 200) with respect to third member 603 and fourth member 604 in first region 610. A stepped portion of electrode assembly holder 600 formed at the end portion of first region 610 is arranged so as not to be in direct contact with electrode assembly 200, thereby suppressing occurrence of a surface pressure difference resulting from the stepped portion.

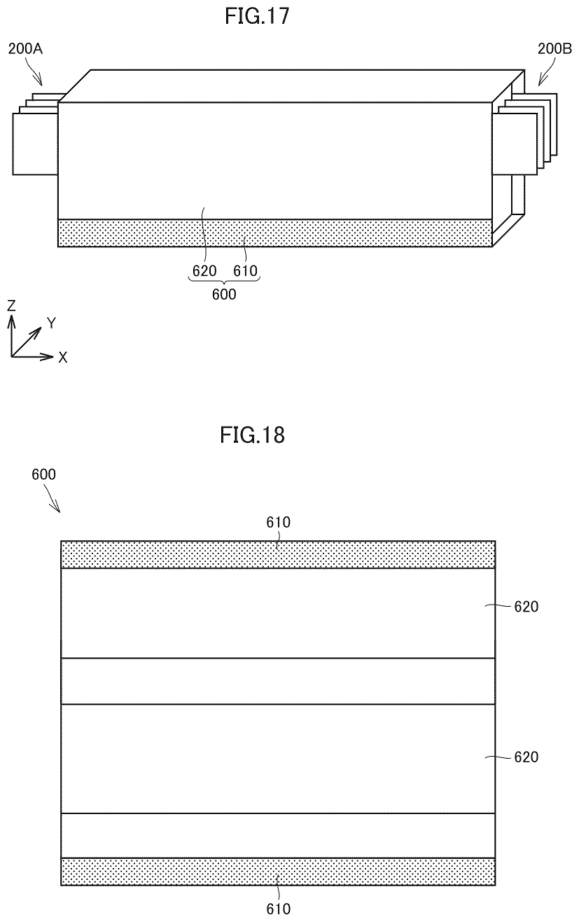

Although each of FIGS. 15 and 16 illustrates the structure in which first regions 610 are provided on both the +Z side and the −Z side, first region 610 may be provided only on the −Z side as in an example of FIG. 17. In this case, as shown in FIG. 18, first region 610 having a large thickness can be provided by winding one sheet member around electrode assembly 200 and overlapping the end portions thereof. Moreover, instead of the example of FIG. 17, first region 610 may be provided only on the +Z side.

As described above, first region 610 can be formed by overlapping the plurality of sheet members constituting electrode assembly holder 600. In the examples of FIGS. 15 to 18, two sheet members are overlapped in first region 610, but three or more sheet members may be overlapped.

Alternatively, first region 610 may be formed by integrating an adhesive layer or a tape with a sheet member instead of the configuration in which the sheet members constituting electrode assembly holder 600 are overlapped. On this occasion, electrode assembly holder 600 is formed to include the adhesive layer or tape integrated with the sheet member.

The thickness of electrode assembly holder 600 in first region 610 is preferably larger than the thickness of electrode assembly holder 600 in second region 620 by about 10 μm or more, more preferably by about 20 μm or more, and further preferably by about 30 μm or more.

First region 610 has a size of about 2 mm or more, more preferably about 5 mm or more, and further preferably about 8 mm or more in the Z direction (second direction).

As shown in FIG. 19, inter-cell separator 2 is disposed to overlap first region 610 of electrode assembly holder 600 as viewed in the Y direction (third direction). The height (size in the Z direction) of the portion of first region 610 that does not overlap inter-cell separator 2 in the Y direction is preferably larger than about 1% of the height (size in the Z direction) of case main body 110. As viewed in the Y direction, first region 610 is preferably disposed to overlap positive electrode plate 220.

The thickness of case main body 110 is, for example, about 0.65 mm in one example. Secondary battery 1 and inter-cell separator 2 are preferably restrained by a load of about 10 kN or more in the Y direction. A restraining pressure in the Y direction by inter-cell separator 2 is, for example, about 0.5 MPa or more and 2 MPa or less.

As described above, since the corner portion of case main body 110 is less likely to be deformed, pressure load is likely to be relatively small in the vicinity of first end side 101 of case main body 110 when the battery assembly is formed with case 100 being restrained in the Y direction. When variation in potential within positive electrode plate 220 of electrode assembly 200 occurs due to variation in the pressure load, the precipitation of metal (precipitation of lithium in a lithium ion battery) may occur.

To address this, in secondary battery 1 according to the present embodiment, since the thickness of electrode assembly holder 600 is made relatively large at first regions 610 located on the both end sides thereof in the Z direction, it is possible to suppress decreased pressure load in the vicinity of first end side 101 of case main body 110. Therefore, the precipitation of lithium (precipitation of metal) can be effectively suppressed at the portion at which the pressure load is likely to be relatively small.

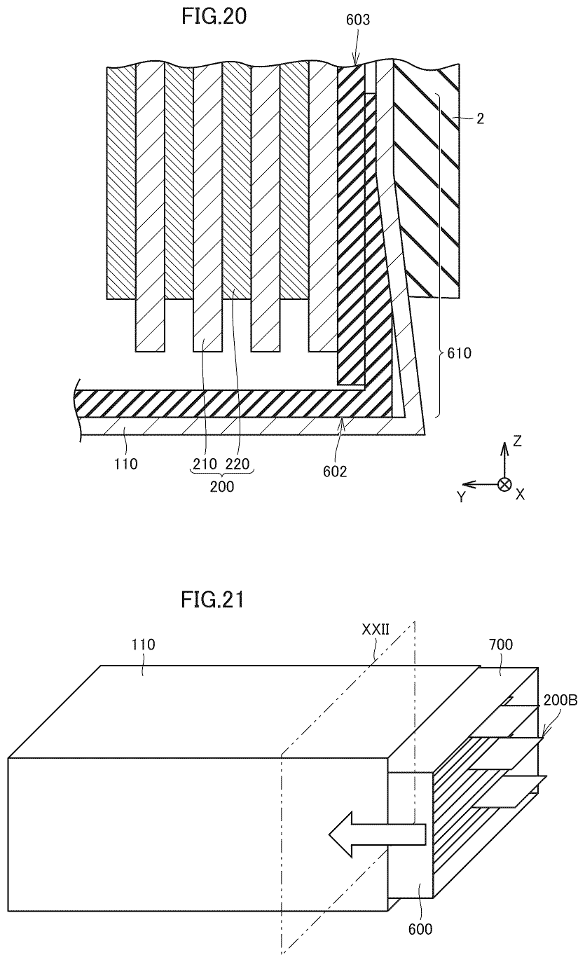

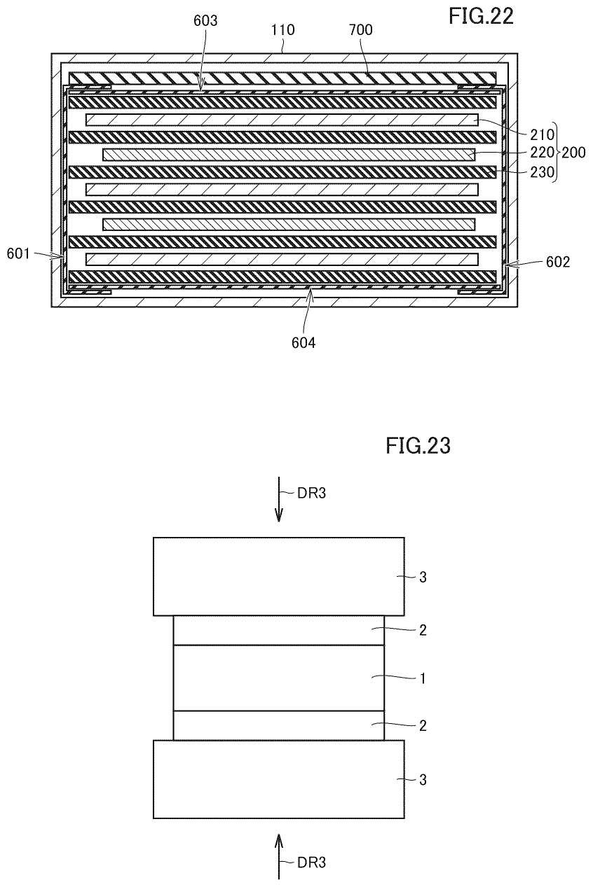

The above functions and effects can be confirmed, for example, based on the following method. As shown in FIGS. 21 and 22, electrode assembly 200, electrode assembly holder 600, and pressure-sensitive paper 700 are inserted into case main body 110 in a state in which pressure-sensitive paper 700 overlaps electrode assembly 200 and electrode assembly holder 600 in the thickness direction (Y direction) of electrode assembly 200. Pressure-sensitive paper 700 is a sheet member that develops a color when a predetermined pressure is applied.

Inter-cell separators 2 are provided on both sides of secondary battery 1, and a compressive load is applied in a direction of arrow DR3 by using a tester 3 that can perform pressing with any load. Thereafter, secondary battery 1 is disassembled to remove pressure-sensitive paper 700 from case main body 110, and a color development range is checked.

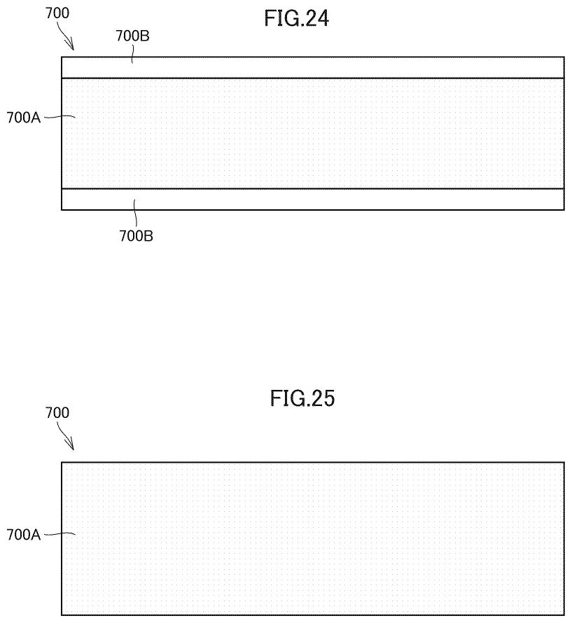

In a secondary battery 1 (comparative example) provided with no first regions 610, a pressure-sensitive region 700A (color development range) is formed on the center side of case main body 110 as shown in FIG. 24, whereas a non-pressure-sensitive region 700B (non-color development region) is formed when the pressure load is low at a portion corresponding to the vicinity of first end side 101.

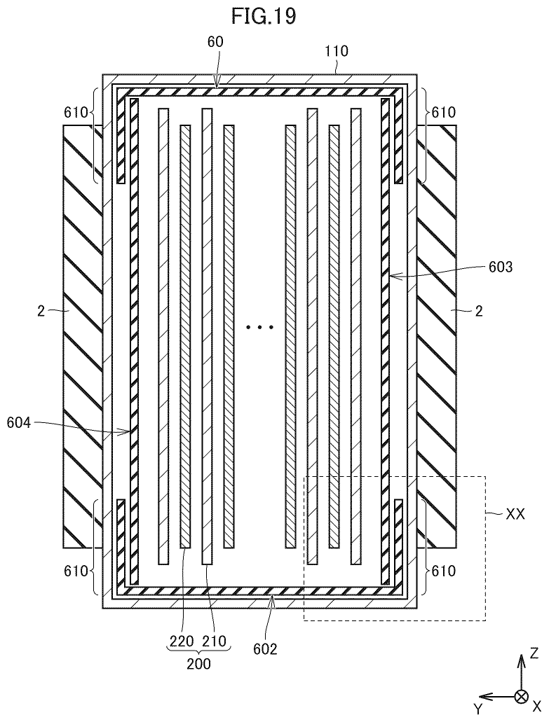

In secondary battery 1 (embodiment) provided with first region 610 shown in FIGS. 15 to 20, a pressure-sensitive region 700A is formed in the entire region of pressure-sensitive paper 700 including a portion corresponding to the vicinity of first end side 101 as shown in FIG. 25. Thus, it can be confirmed that decreased pressure load at the portion corresponding to the vicinity of first end side 101 is suppressed.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery comprising:
an electrode assembly including a main body portion and an electrode tab;
an insulating member provided outside the electrode assembly; and
an exterior container that has a prismatic shape and that accommodates the electrode assembly and the insulating member, wherein
the exterior container has a pair of first surfaces, a pair of second surfaces substantially orthogonal to the first surfaces, and a pair of third surfaces substantially orthogonal to the first surfaces and the second surfaces, and an area of each of the first surfaces is larger than each of an area of each of the second surfaces and an area of each of the third surfaces,
the first surface has a substantially rectangular shape including a pair of first end sides each extending in a first direction and a pair of second end sides each extending in a second direction substantially orthogonal to the first direction,
the insulating member has a first region provided in a vicinity of at least one of the pair of first end sides and extending in a form of a strip in the first direction, and has a second region located on a center side of the insulating member with respect to the first region in the second direction,
the first region and the second region are provided to overlap the main body portion of the electrode assembly in a third direction orthogonal to the first direction and the second direction, and
a thickness of the insulating member in the first region is larger than a thickness of the insulating member in the second region.

2. The secondary battery according to claim 1, wherein the first region is provided in a vicinity of each of the pair of first end sides.

3. The secondary battery according to claim 1, wherein the first region is provided across an entire length of the main body portion of the electrode assembly in the first direction.

4. The secondary battery according to claim 1, wherein in the first region, a plurality of sheet members constituting the insulating member are overlapped.

5. The secondary battery according to claim 1, wherein in the first region, an adhesive layer or a tape is integrated with the insulating member.

6. The secondary battery according to claim 1, wherein the pair of first end sides are long sides.

7. The secondary battery according to claim 1, wherein the electrode assembly has an electrode tab at a position facing each of the pair of second end sides.

8. The secondary battery according to claim 1, wherein the electrode assembly is a stacked type electrode assembly.

9. The secondary battery according to claim 1, wherein a thickness of the insulating member in the first region is larger than a thickness of the insulating member in the second region by 10 μm or more.

10. The secondary battery according to claim 1, wherein the first region has a width of 2 mm or more in the second direction.

11. The secondary battery according to claim 1, wherein
the first region is provided in a vicinity of each of the pair of first end sides, the first region is provided across an entire length of the main body portion of the electrode assembly in the first direction,
in the first region, a plurality of sheet members constituting the insulating member are overlapped,
in the first region, an adhesive layer or a tape is integrated with the insulating member,
the pair of first end sides are long sides,
the electrode assembly has an electrode tab at a position facing each of the pair of second end sides,
the electrode assembly is a stacked type electrode assembly,
a thickness of the insulating member in the first region is larger than a thickness of the insulating member in the second region by 10 μm or more,
the first region has a width of 2 mm or more in the second direction.

12. A battery assembly comprising:
a plurality of the secondary batteries according to claim 11, the plurality of the secondary batteries being arranged side by side in the third direction; and
an inter-cell separator provided between the plurality of the secondary batteries, wherein
the inter-cell separator is disposed to overlap the first region of the insulating member as viewed in the third direction.

13. A battery assembly comprising:
a plurality of the secondary batteries according to claim 1, the plurality of the secondary batteries being arranged side by side in the third direction; and
an inter-cell separator provided between the plurality of the secondary batteries, wherein
the inter-cell separator is disposed to overlap the first region of the insulating member as viewed in the third direction.

14. The battery assembly according to claim 13, wherein the plurality of the secondary batteries and the inter-cell separator are restrained by a load of 10 kN or more in the third direction.
